(19) United States
(12) Patent Application Publication
(10) Pub. No.: US 2014/0067739 A1
(43) Pub. Date: Mar. 6, 2014

(54) REDUCTION OR ELIMINATION OF TRAINING FOR ADAPTIVE FILTERS AND NEURAL NETWORKS THROUGH LOOK-UP TABLE

(71) Applicant: BAE Systems Information and Electronics Systems Integration Inc., Nashua, NH (US)

(72) Inventors: Brandon P. Hombs, Merrimack, NH (US); Joseph Farkas, Merrimack, NH (US); John A. Tranquilli, JR., Amherst, NH (US)

(73) Assignee: BAE Systems Information and Electronics Systems Integration Inc., Nashua, NH (US)

(21) Appl. No.: 14/013,277

(22) Filed: Aug. 29, 2013

Related U.S. Application Data
(60) Provisional application No. 61/694,285, filed on Aug. 29, 2012.

(51) Int. Cl. G06N 3/08

(52) U.S. Cl. CPC G06N 3/08
USPC 706/25

(57) ABSTRACT

A system and method of reducing or eliminating training for adaptive receiver and neural networks is disclosed. The adaptive filter or neural network is pre-training using simulation or empirically received data and a took-up table is created. Coefficient instantiation from the receiver for ail permutations of the key parameters of training data are stored along with the key parameters within the look-up table. After creating the look-up table, the key parameters of the signal to be decoded are estimated. The coefficient of filter or neural network for the estimated key parameters is obtained by accessing the loop-up table. The demodulated signal is produced by setting the filter or neural network coefficents to coefficient values obtained from the look-up table. For slow varying key parameters, the coefficients from the lookup table are occasionally replaced instead of implementing the adaptive filter or neural network.

### CROSS-REFERENCE TO RELATED APPLICATIONS

This Application claims rights under 35 USC §119(e) from U.S. Application Ser. No. 61/694,285 filed 29-Aug.-2012, the contents of which are incorporated herein by reference.

### TECHNICAL FIELD

Embodiments are generally related signal processing. Embodiments are also related to system and method for decoding signals. Embodiments are additionally related to system and method of reducing or eliminating training for adaptive filters and neural networks through look-up table.

### BACKGROUND OF THE INVENTION

Conventional communication systems send known information to “train” an adaptive filter or neural network. Training consists of sending known data from a transmitter, measuring the error between the known signal and decoded signal and then adjusting the coefficients of adaptive filter or neural network to reduce the error. In an adaptive filter, the coefficients are filter taps. In a neural network, the coefficients are weighs in the neural network. The amount of training dictates the accuracy of the filter or neural network. After the training, the filter or neural network is used to decode the information bits. Building an adaptive filter or neural network as a decoding technique is valuable, but often complex to implement.

An adaptive fitter or neural network based receiver uses training to adapt coefficient weighting which adjusts the filter or neural network to determine the best way to decode the underlying symbols in a communication system. The training consists of known symbols sent from a transmitter. The receiver uses the known training symbols to adapt its coefficient weightings. After training, the adaptive filter or neural network will have the correct coefficient taps and will be able to decode the unknown data symbols that typically come right after training. Sending known training symbols means that, the communication network has less time to send the unknown data symbols, resulting in decreased data rate and throughput.

A need, therefore, exists for a way to reduce or eliminate training for adaptive filters or neural networks.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the present invention to provide for signal processing.

It is another aspect of the disclosed embodiment to provide for system and method for decoding signals.

It is a further aspect of the disclosed embodiment to provide system and method of reducing or eliminating training for adaptive filters and neural networks through a look-up table.

The aforementioned aspects and other objectives and advantages can now be achieved as described herein. A system and method of reducing or eliminating training for adaptive receiver and neural networks is disclosed. A adaptive filter or neural network is pre-trained using simulation or empirically received data and a look-up table is created. Coefficient instantiation from the receiver for all permutations of the key parameters such as amplitude, frequency, phase, timing, codes of training data are stored along with the key parameters within the look-up table.

After creating the look-up table, the key parameters of the signal to be decoded are estimated. The coefficient of filter or neural network for the estimated key parameters is obtained by accessing the loop-up table. The demodulated signal is produced by setting the filter or neural network coefficents to coefficient values obtained from the look-up table. For slow varying key parameters, the coefficients from the lookup table are occasionally replaced instead of implementing the adaptive filter or neural network.

The reduction or elimination of training adaptive receiver and neural networks increases the throughput of each user by replacing the training bits with information bits. Additionally, if the estimated parameters are slowly varying, the reduction or elimination drastically reduce the complexity of implementing an adaptive filter or neural network.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a simplified block diagram of a system of reducing or eliminating training for adaptive receiver through a look-up table, in accordance with the disclosed embodiments;

FIG. 2 illustrates a block diagram depicting a process of creating the pre-trained lookup table from either simulation or empirically received, in accordance with the disclosed embodiments; and

FIG. 3 illustrates a flow chart depicting the process of reducing or eliminating training for adaptive receiver through a look-up table, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

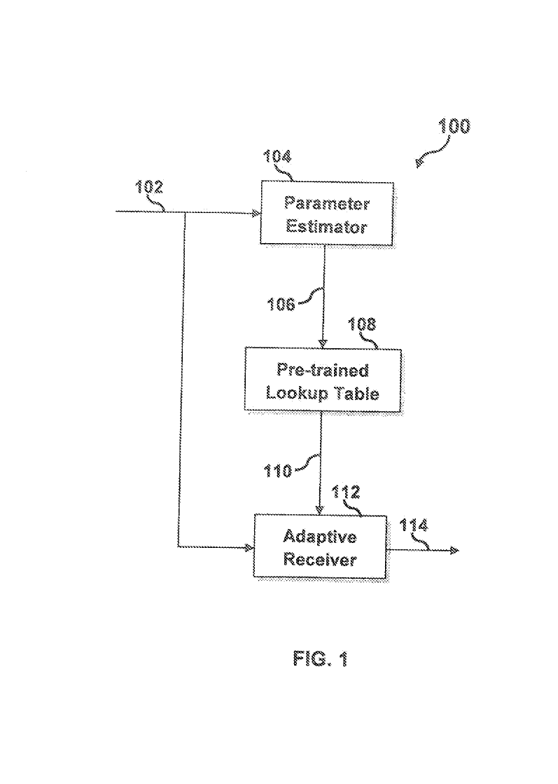

FIG. 1 illustrates a simplified block diagram of a system 100 of reducing or eliminating training for adaptive receiver 112 through a look-up table 108, in accordance with the disclosed. The incoming signal 102 enters to a parameter estimator 104 which estimates the key parameters 106 of the incoming signal 102. The coefficients 110 of adaptive receiver 112 are obtained by accessing a pre-trained lookup table 108. The coefficient 110 is fed to the adaptive receiver 112 along with the incoming signal 102, to produce a demodulated output 114.

Note that the pre-trained lookup table is constructed that consists of the adaptive filter or neural network coefficients with all permutations of key parameters. The key parameters may include timing, amplitude, frequency, phase, codes, etc. Also, note that when the parameters are varying slowly enough so that the filter does not have to be updated often, parameters can occasionally be re-estimated and new coefficients applied to the adaptive filter or neural network from the lookup table.

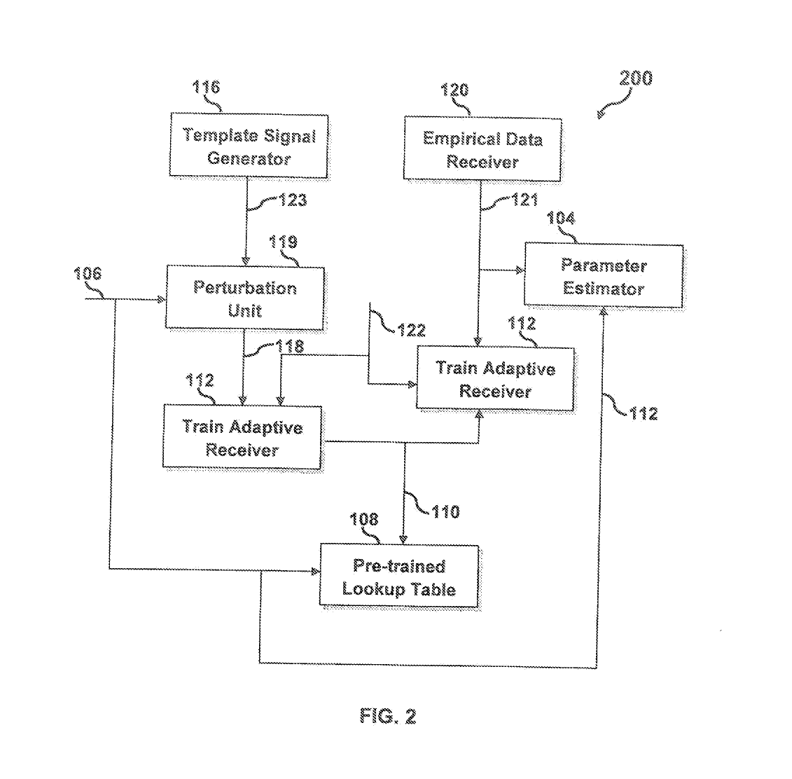

Referring to FIG. 2, a block diagram illustrating a process 200 of creating the pre-trained lookup table 108 from either simulation or empirically received data is depicted. For simulated data, a template signal generator 116 creates the original signal 123. The signal 123 is fed to a perturbation unit 119 where the signal 123 loops over the ranges of key parameters 106 to create perturbed signals 118. The perturbed signals 118 is feed to the adaptive receiver 112 along with known training data 122 so that the receiver adapts. The output coefficient instantiation 110 from the receiver 112 is then stored along with the key parameters 106 within the pre-trained lookup 108 for the ranges of key parameters 106.

Conversely, the lookup table 108 can also be generated with the empirical data 121. The empirical data 121 from empirical data receiver 120 is first passed through the parameter estimator 104 used in the system 100 described in FIG. 1. Again, known training data 122 is used to train the adaptive receiver 112 and produce a coefficient instantiation 110 The coefficient instantiation 110 and key parameters 106 are stored within the pre-trained lookup 108.

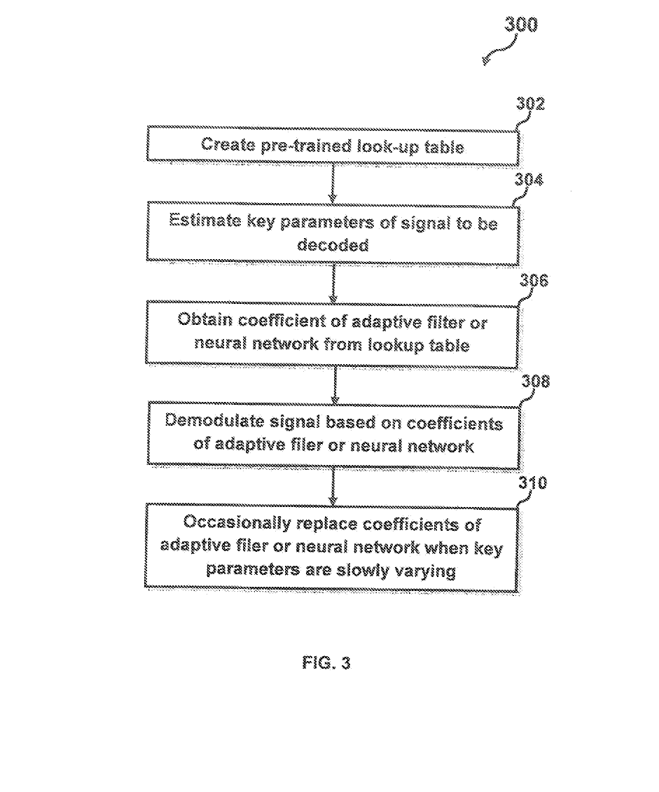

FIG. 3 illustrates a flow chart depicting the process 300 of reducing or eliminating training for adaptive filters and neural networks through a look-up table. As said at block 302, a pre-trained look-up table is created by training adaptive filter or neural network with simulation or empirically received data as depicted in FIG. 2. The look-up table comprises all permutations of key parameters and coefficient of adaptive filter or neural network. After creating the lookup table, the key parameters of signal to be decoded are estimated as said at block 304. The coefficient of adaptive filter or neural network corresponding to the key parameter are obtained from lookup table as illustrated at block 306. The coefficient of adaptive filter or neural network is set according to the coefficient value obtained from lookup table and then demodulation of the signal is performed as depicted at block 308. As said at block 310, when the key parameters are slowly varying, the coefficients of adaptive filer or neural network are occasionally replaced.

Note that the computational complexity for the method is much less than to update the adaptive filter or neural network per symbol. The lookup table can be constructed from simulations instead of building a real-time version of the adaptive filter or neural network. Also the method can be used to start the training of an adaptive filter or neural network from a lookup table and finish training with a smaller amount of known symbols, reducing the amount of overhead otherwise necessary.

Also note that, the adaptive filter and neural network based techniques are occasionally used when building a Multi User Detector (MUD). When building a neural network based MUD, a lot of training is often required which can be reduced or eliminated using the method. For example, in a neural network based two users MUD, when the amplitude of the received signals completely dictates the coefficient weightings of the neural network, instead of periodically training the MUD, a lookup table is created. It consists of the neural network coefficient weightings for different received amplitudes of the two users. Training of the neural based MUD is completely replaced with the lookup table function.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for decoding a signal, comprising
creating a pre-trained look-up table comprising a plurality of key parameters of training signal and a corresponding coefficient of an adaptive filter or neural network, wherein said pre-trained look-up table is obtained by training said adaptive filter or neural network;
estimating at least one key parameter of a signal to be decoded; and
accessing said pre-trained look-up table to obtain a filter or neural network coefficient for estimated said at least one key parameter.

2. The method of claim 1 wherein said pre-trained look-up table is created from simulation.

3. The method of claim 1 wherein said pre-trained look-up table is created from empirically received data.

4. The method of claim 1 wherein said pre-trained look-up table is pre-populated with all permutations of said key parameters.

5. The method of claim 1 wherein said plurality of key parameters comprises frequency, phase, timing, amplitude and codes.

6. The method of claim 1 wherein said adaptive filter or neural network coefficient is occasionally replaced from said pre-trained lookup table for a slowly varying key parameters.

7. A method for decoding a signal, comprising
creating a pre-trained look-up table comprising a plurality of key parameters of training signal and a corresponding coefficient of an adaptive filter or neural network, wherein said pre-trained look-up table is obtained by training said adaptive filter or neural network wherein said pre-trained look-up table is pre-populated with all permutations of said key parameters, and said plurality of key parameters comprises frequency, phase, timing, amplitude and codes;
estimating at least one key parameter of a signal to be decoded; and
accessing said pre-trained look-up table to obtain a filter or neural network coefficient for estimated said at least one key parameter.

8. The method of claim 7 wherein said pre-trained look-up table is created from simulation.

9. The method of claim 7 wherein said pre-trained look-up table is created from empirically received data.

10. The method of claim 7 wherein said adaptive filter or neural network coefficient is occasionally replaced from said pre-trained lookup table for a slowly varying key parameters.

11. A system for decoding a signal, comprising
a pre-trained look-up table comprising a plurality of key parameters of a training signal and a corresponding coefficient of an adaptive filter or neural network, wherein said pre-trained look-up table is created by training said adaptive filter or neural network; and
a parameter estimator for estimating at least one key parameter of a signal to be decoded, wherein said pre-trained look-up table is accessed to obtain a filter or neural network coefficient for the estimated at least one key parameter.

12. The system of claim 7 wherein said pre-trained look-up table is created from simulation.

13. The system of claim 7 wherein said pre-trained look-up table is created from empirically received data.

14. The system of claim 7 wherein said pre-trained look-up table is pre populated with all permutations of said key parameters.

15. The system of claim 7 wherein said plurality of key parameters comprises frequency, phase, timing, amplitude and codes.

16. The system of claim 7 wherein said adaptive filter or neural network coefficient is occasionally replaced from said pre-trained lookup table for slowly varying key parameters.
